(19) United States
(12) Patent Application Publication
(10) Pub. No.: US 2020/0157298 A1
(43) Pub. Date: May 21, 2020

(54) SELF-ASSEMBLED 2-D LAYERED SHEET STRUCTURE BASED POLYMERIC MATERIAL USING NON-CONVENTIONAL FILLER FOR ENHANCED HEAT DISSIPATION FOR THERMAL MANAGEMENT APPLICATIONS

(71) Applicants: Jiahua ZHU, Fairlawn, OH (US); Nitin MEHRA, Oceanside, CA (US)

(72) Inventors: Jiahua ZHU, Fairlawn, OH (US); Nitin MEHRA, Oceanside, CA (US)

(73) Assignee: THE UNIVERSITY OF AKRON, AKRON, OH (US)

(21) Appl. No.: 16/686,397

(22) Filed: Nov. 18, 2019

Related U.S. Application Data
(60) Provisional application No. 62/768,304, filed on Nov. 16, 2018.

(51) Int. Cl. C08J 5/18; C08L 29/04

(52) U.S. Cl. CPC C08J 5/18; C08J 2461/28; C08J 2329/04; C08L 29/04

(57) ABSTRACT

In one or more embodiments, the present invention provides a heat dissipating polymer materials (and films thereof) that utilize supramolecular chemistry. In various embodiments, these materials comprise networks of hydrogen bonded supramolecular crystals, self-assembled into aligned 2-D layered sheet structures that are distributed throughout a polymer matrix. In some of these embodiments, the heat dissipating polymer materials are prepared by in-situ co-precipitation of melamine and cyanuric acid in a PVA polymer resulting in homogenous distribution of MC crystals and the eventual formation of a network of hydrogen bonded melamine-cyanurate (MC) 2-D layered sheet structures throughout the PVA polymer.

### CROSS REFERENCE TO RELATED APPLICATIONS

This application claims the benefit of U.S. provisional patent application Ser. No. 62/768,304 entitled “Self-Assembled 2-D Layered Sheet Structure Based Polymeric Material Using Non-Conventional Filler for Enhanced Heat Dissipation for Thermal Management Applications,” filed Nov. 16, 2018, and incorporated herein by reference in its entirety.

### FIELD OF THE INVENTION

One or more embodiments of the present invention relates to a heat dissipating material. In certain embodiments, the present invention relates to non-conventional polymeric filler materials for use in heat dissipating materials.

### BACKGROUND OF THE INVENTION

Thermal management is becoming increasingly important across several industries such as aerospace, automobile, electronic packaging etc. to make devices more energy efficient with longer life time and reliability. For example, the generation and accumulation of heat have greatly influence the performance and even safety of electronics including LEDs, batteries, solar cells, etc. Global thermal Management technology market is USD 11.7 Billion (2015). Out of this, the market for thermal interface materials based on polymer composites is currently estimated to be around USD 667.5 million. It is estimated that the computer industry accounts for around 60% of these materials. In the computer and processor industry, the rapid miniaturization of electronic devices and components has led to dramatic increase in heat generation in smaller area. Therefore, the demands of device cooling have urged the development of highly efficient thermally conductive materials.

Polymers feature various advantages including easy processing, low cost and tunable mechanical properties. Unfortunately, however, their thermal conductivity (TC) is usually low. In the past several years, significant efforts have been made to improve the TC of polymers via incorporating thermally conductive materials such as, metals, ceramics and carbon fillers. Almost all thermal conductive plastics are based on ceramic/metallic filler-resin combinations with high filler loadings of from 30% to 80%. For these thermal conductive plastics, the general rule is that the higher the loading, the higher the thermal conductivity. This greatly degrades their mechanical properties, making them brittle, increases their weight, and makes them more difficult to fabricate, while increasing their cost due to the need for expensive ceramic/carbon/metallic fillers.

The effectiveness of thermal conduction in these composites depends on the structure/or network of the thermal fillers. Orientation of thermal fillers and strengthening of polymer/filler interface have been demonstrated to be effective approaches to improve the TC of the composites. Although TC of frequently used fillers may be 500-1000 factors higher than the neat polymer, enhancement in TC is limited to 10-50 times which is several factors off. The main bottleneck of realizing the full TC of these fillers is the massive phonon scattering at polymer/filler interfaces. Using the rule of mixing of weighted averages of the filler material, the entire TC of the filler is not translated into the polymer composite due to phonon scattering. Therefore, efforts to look into alternative strategies are necessary in order to further push the limits of TC of polymer composites.

A supramolecule is the molecular cooperative assembly between complimentary molecules leading to spontaneous formation of stable aggregates with the presence of non-covalent interactions. Such interactions play a major role in supramolecular chemistry, which mainly encompass non covalent interactions including, but not limited to, hydrogen bonding, metal-ligand, π-π interaction, and ionic bonding. Recent studies have shown the impact of engineering intermolecular interactions to drive heat conduction within polymers. The wide scope for fine tuning of various non-covalent interactions in supramolecular assemblies could be an alternative strategy to develop heat dissipating materials. Multiple hydrogen bonding is often associated in the formation of these supramolecular aggregates and can provide thermal highways for the transport of phonons.

Another vital characteristic of supramolecular assembles that makes them a suitable candidate for thermal conduction is their ability to form stable crystal structures. Shapes and sizes of crystal structure can have significant impact on the thermal conduction properties of polymeric materials. There are several complementary molecular motifs which can assemble into stable aggregate resulting from the non-covalent interactions. One of these is a combination of melamine and cyanuric acid (MC), which assemble together to form a rosette arrangement. (See FIG. 1) Supramolecular assemblies have been used in several applications like development of nano/micro scaled structures, organogels, polymeric scaffolds, membrane, and sensors, to name a few.

What is needed in the art is a heat dissipating polymer material that utilizes supramolecular chemistry to overcome, or at least minimize, the poor filler dispersion and enormous phonon scattering issues of known heat dissipating polymer materials.

### SUMMARY OF THE INVENTION

In one or more embodiments, the present invention provides a heat dissipating polymer material that utilizes supramolecular chemistry to overcome, or at least minimize, the poor filler dispersion and enormous phonon scattering issues of known heat dissipating polymer materials. In one or more embodiments, the heat dissipating polymer materials comprise networks of hydrogen bonded supramolecular crystals self-assembled from supramolecule forming compounds into aligned 2-D layered sheet structures distributed throughout a polymer having, or functionalized to have, two or more functional groups that form hydrogen or ionic bonds. In one or more of these embodiments, these supramolecule forming compounds form self-aligned 2-D sheet structure in polymer without any aid of external agent like magnetic field or electrical field.

In some of these embodiments, the heat dissipating polymer materials of the present invention are prepared by in-situ co-precipitation of melamine and cyanuric acid in a PVA polymer resulting in homogenous distribution of MC crystals and the eventual formation of a network of hydrogen bonded melamine-cyanurate (MC) 2-D layered sheet structures throughout the PVA polymer. It has been found that the extensive network of multiple hydrogen bonds present in this supramolecular assembly along with aligned layered structure facilitate efficient phonon transport thereby improving the thermal conductivity (TC) of the polymer. It is believed that these 2D sheet structures serve as highways for thermal conduction. In various embodiments, a 65% enhancement of TC can be achieved by incorporating 2D MC crystals into polymer composites. Moreover, these materials are highly cost effective as do not require expensive fillers, are easy to fabricate, and significantly reducing both processing time and cost. In various embodiments, the heat dissipating polymer materials of the present invention provide a new strategy for the design and development of thermally conductive materials via supramolecular assembling.

In a first aspect, the present invention is directed to a heat dissipating polymer composition comprising: a substantially electrically non-conductive polymer; and a self-assembling and self-aligning supramolecular filler material; wherein step self-assembling and self-aligning supramolecular filler material comprises a plurality of substantially aligned 2D sheets. In one or more of these embodiments, the substantially electrically non-conductive polymer is selected from the group consisting of poly(vinyl alcohol), polyvinyl propylene, polyamides, polyacrylic amides, polysaccharides, polyacrylic acids, polyurethanes with polyethylene glycol ether soft segments, and combinations, copolymers and grafts thereof.

In one or more embodiments, the heat dissipating polymer composition of the present invention includes any one or more of the above referenced embodiments of the first aspect of the present invention wherein step substantially electrically non-conductive polymer is poly(vinyl alcohol). In some embodiments, the heat dissipating polymer composition of the present invention includes any one or more of the above referenced embodiments of the first aspect of the present invention wherein step self-assembling and self-aligning supramolecular filler material comprises one or more of melamine and cyanuric acid, adenine and guanine, thymine and adenine, cytosine and guanine or two or more ureidopyrimidinone derivatives.

In one or more embodiments, the heat dissipating polymer composition of the present invention includes any one or more of the above referenced embodiments of the first aspect of the present invention wherein self-assembling and self-aligning supramolecular filler material comprises from about 20 wt % to about 80 wt % of step heat dissipating polymer composition. In some embodiments, the heat dissipating polymer composition of the present invention includes any one or more of the above referenced embodiments of the first aspect of the present invention having a thermal conductivity of from about 0.3 W/m·K to about 1.0 W/m·K. In one or more embodiments, the heat dissipating polymer composition of the present invention includes any one or more of the above referenced embodiments of the first aspect of the present invention wherein the molar ratio of melamine to cyanuric acid is about 1:1.

In a second aspect, the present invention is directed to a heat dissipating polymer composite film comprising the heat dissipating polymer composition described above. In one or more of these embodiments, the self-assembling and self-aligning supramolecular filler material comprises from about 20 wt % to about 80 wt % of step heat dissipating polymer composition. In some embodiments, the heat dissipating polymer composite film of the present invention includes any one or more of the above referenced embodiments of the second aspect of the present invention having a thickness of from about 10 microns to about 1 cm. In one or more embodiments, the heat dissipating polymer composite film of the present invention includes any one or more of the above referenced embodiments of the second aspect of the present invention having a thermal conductivity of from about 0.3 W/m·K to about 1.0 W/m·K.

In one or more embodiments, the heat dissipating polymer composite film of the present invention includes any one or more of the above referenced embodiments of the second aspect of the present invention wherein the substantially electrically non-conductive polymer comprises poly(vinyl alcohol). In some embodiments, the heat dissipating polymer composite film of the present invention includes any one or more of the above referenced embodiments of the second aspect of the present invention wherein the self-assembling and self-aligning supramolecular filler material comprises melamine and cyanuric acid.

In a third aspect, the present invention is directed to a method for making the heat dissipating polymer composite film of claim 8 comprising: dissolving the substantially electrically non-conductive polymer in deionized water; separately dissolving melamine and cyanuric acid in deionized water to form a melamine solution and a cyanuric acid solution; separately adding the melamine solution and the cyanuric acid solution to the polymer solution; mixing the resulting solution at a temperature of from 25° C. to about 90° C. for from about 10 min to about 5 hours, wherein the melamine and cyanuric acid will self-assemble to form a plurality of substantially aligned 2D sheets within step substantially electrically non-conductive polymer; pouring the solution into a flat-bottomed container or onto a surface and drying it at a temperature of from about 25° C. to about 70° C. for from 1 to 7 days to form a freestanding film. In some embodiments, the method the present invention further comprises heating step freestanding film at a temperature of 40° C. to about 80° C. for from 1 to 48 hours to remove any remaining solvent.

In one or more embodiments, the method the present invention includes any one or more of the above referenced embodiments of the third aspect of the present invention wherein the substantially electrically non-conductive polymer is polyvinyl alcohol. In some embodiments, the method the present invention includes any one or more of the above referenced embodiments of the third aspect of the present invention wherein the molar ratio of the molar ratio of melamine to cyanuric acid about 1:1.

In one or more embodiments, the method the present invention includes any one or more of the above referenced embodiments of the third aspect of the present invention wherein step melamine and cyanuric acid together comprise from about 5 wt % to about 80 wt % of step heat dissipating polymer composition. In some embodiments, the method the present invention includes any one or more of the above referenced embodiments of the third aspect of the present invention wherein step melamine and cyanuric acid together comprise from about 20 wt % to about 80 wt % of step heat dissipating polymer composition.

### BRIEF DESCRIPTION OF THE DRAWINGS

For a more complete understanding of the features and advantages of the present invention, reference is now made to the detailed description of the invention along with the accompanying figures in which:

FIG. 1 is a schematic diagram showing the hydrogen bonding assembly of the multiple hydrogen bonded supramolecular crystal, melamine-cyanurate (MC). The dashed lines represent hydrogen bonding.

FIGS. 2A-D are optical microscopy images of M-10 (FIG. 2A), C-10 (FIG. 2B), MC-P-10 (FIG. 2C), MC-10 (FIG. 2D). Scale bar is 1 mm.

FIGS. 3A-I are SEM images showing a cross section of MC-1 (FIG. 3A), MC-5 (FIG. 3B), MC-10 (FIG. 3C), MC-20 (FIG. 3D), MC-40 (FIG. 3E), MC-50 (FIG. 3F), M-10 (FIG. 3G), C-10 (FIG. 3H), and MC-P-10 (FIG. 3I). Images on top right are their respective photos showing their relative opacity. Scale Bar—50 μm. The University of Akron logo is reproduced with permission from The University of Akron.

FIG. 4 is a schematic illustration a mechanism for self-assembled MC sheet stacking according to one or more embodiments of the present invention.

FIG. 5 is a comparison of the XRD diffraction of (a) PVA (b) MC Powder (c) MC-5 (d) MC-10 and (e) MC-50.

FIG. 6 is a comparison of Fourier Transform Infrared Spectroscopy (FTIR) spectra of PVA, MC powder and various PVA-MC composites.

FIG. 7 is a comparison of the solid-state NMR plots of MC composites.

FIGS. 8A-B is a comparison of topography images for pure PVA (FIG. 8A) and MC-50 (FIG. 8B).

FIGS. 9A-B is a comparison of SThM images of pure PVA (FIG. 9A) and MC-50 (FIG. 9B). Scan size is 10×10 μm.

FIG. 10 is a graph comparing the thermal conductivity of PVA, M-10, C-10, MC-P-10, CM-10, and MC-10 samples at 10 wt % loading.

FIG. 11 is a graph showing the thermal conductivity of composites of PVA-MC at different loadings.

FIG. 12 is a schematic showing the mechanism for phonon transport in PVA-MC composite at high loading.

FIG. 13 is a graph showing thermal conductivity as a function of temperature for PVA and MC-50.

FIG. 14 is a graph showing the results of heat dissipation tests for PVA and MC-50. The rounds inserts are Thermal Camera images showing which film has higher temperature with respect to time when for both pure PVA and MC-50.

The patent or application file contains at least one drawing executed in color. Copies of this patent or patent application publication with color drawing(s) will be provided by the Office upon request and payment of the necessary fee.

### DETAILED DESCRIPTION OF THE ILLUSTRATIVE EMBODIMENTS

The following is a detailed description of the disclosure provided to aid those skilled in the art in practicing the present disclosure. Those of ordinary skill in the art may make modifications and variations in the embodiments described herein without departing from the spirit or scope of the present disclosure. Unless otherwise defined, all technical and scientific terms used herein have the same meaning as commonly understood by one of ordinary skill in the art to which this disclosure belongs. The terminology used in the description of the disclosure herein is for describing particular embodiments only and is not intended to be limiting of the disclosure.

In one or more embodiments, the present invention provides a heat dissipating polymer material that utilizes supramolecular chemistry to overcome, or at least minimize, the filler dispersion and enormous phonon scattering issues of known heat dissipating polymer materials. In one or more embodiments, the heat dissipating polymer materials comprise networks of hydrogen bonded supramolecular crystals self-assembled from supramolecule forming compounds into aligned 2-D layered sheet structures distributed throughout a polymer having, or functionalized to have one or more functional groups that form hydrogen or ionic bonds. In one or more of these embodiments, these supramolecule forming compounds aggregate to form self-aligned 2-D sheet structures in the polymer without any aid of external agent like magnetic field or electrical field. It has been found that the extensive network of multiple hydrogen bonds present in this supramolecular assembly, along with the aligned layered structure, facilitate efficient phonon transport thereby improving the thermal conductivity (TC) of the polymer. As set forth before, it is believed that these 2D sheet structures serve as highways for thermal conduction.

In some of these embodiments, the heat dissipating polymer materials of the present invention are prepared by in-situ co-precipitation of melamine and cyanuric acid in a PVA polymer resulting in homogenous distribution of MC crystals and the eventual formation of a network of hydrogen bonded melamine-cyanurate (MC) 2-D layered sheet structures throughout the PVA polymer. In various embodiments, a 65% enhancement of TC can be achieved by incorporating 2D MC crystals into polymer composites. Moreover, these materials are highly cost effective as do not require expensive fillers, are easy to fabricate, and significantly reducing both processing time and cost. In various embodiments, the heat dissipating polymer materials of the present invention provide a new strategy for the design and development of thermally conductive materials via supramolecular assembling. Potential applications for the heat dissipating polymer materials of the present invention may include, without limitation, thermal interface materials, thermal pads, and electronic packaging.

The following terms may have meanings ascribed to them below, unless specified otherwise. As used herein, the terms “comprising” “to comprise” and the like do not exclude the presence of further elements or steps in addition to those listed in a claim. Similarly, the terms “a,” “an” or “the” before an element or feature does not exclude the presence of a plurality of these elements or features, unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein in the specification and the claim can be modified by the term “about.” It should also be also understood that the ranges provided herein are shorthand for all of the values within the range and, further, that the individual range values presented herein can be combined to form additional non-disclosed ranges. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50.

All publications, patent applications, patents, and other references mentioned herein are expressly incorporated by reference in their entirety, which means that they should be read and considered by the reader as part of this text. That the document, reference, patent application, or patent cited in this text is not repeated in this text is merely for reasons of conciseness. In the case of conflict, the present disclosure, including definitions, will control. All technical and scientific terms used herein have the same meaning.

Further, any compositions or methods provided herein can be combined with one or more of any of the other compositions and methods provided herein. The fact that given features, elements or components are cited in different dependent claims does not exclude that at least some of these features, elements or components maybe used in combination together.

In a first aspect, the present invention is directed to a heat dissipating polymer composition comprising a substantially electrically non-conductive polymer and a self-assembling and self-aligning supramolecular filler material formed into a plurality of substantially aligned 2D sheets. As will be apparent, the polymer acts as a matrix within which the supramolecular filler material assembles into 2D sheets. And because most applications for the heat dissipating polymer compositions of the present invention are electrical in nature, it is strongly preferred, but not absolutely required, that the polymer forming the matrix of the composition be substantially electrically non-conductive. As used herein, the term “substantially electrically non-conductive” is used to refer to a polymer that does not conduct essentially any electricity under normal operating conditions. In embodiments where the heat dissipating polymer composition of the present invention is being used in connection with a computer or other electronic device, use of a substantially electrically non-conductive polymer to form the matrix of the material is advantageous to prevent short circuits of the electronic device through the heat dissipating polymer composition. This feature is, of course, of much less importance where the application for the heat dissipating polymer composition does not involve electronics or electricity.

In one or more embodiment, the polymers will contain one or more groups capable of intermolecular interactions. In one or more of these embodiments, the polymers will have, or be functionalized to have, one or more groups capable of forming hydrogen or ionic bonds.

In one or more embodiments, the substantially electrically non-conductive polymer may include, without limitation, poly(vinyl alcohol), polyvinyl propylene, polyamides, polyacrylic amides, polysaccharides, polyacrylic acids, polyurethanes with polyethylene glycol ether soft segments, or various combinations, copolymers and grafts thereof. In some embodiments, the substantially electrically non-conductive polymer is poly(vinyl alcohol). In some other embodiments, the substantially electrically non-conductive polymer is polyvinyl propylene.

The molecular weight of the polymers used for the present invention is not particularly limited in that present invention does not require any particular accommodation with respect to molecular weight. As will be apparent, the molecular weights of the polymers chosen will depend upon the particular polymer being used and the particular application. One of ordinary skill in the art will be able to select a suitable polymer for a particular application and determine a suitable molecular weight for that polymer without undue experimentation.

Similarly, the glass transition temperature (T_{g}) and degradation temperature (T_{d}) are not particularly limited in that present invention does not require any particular accommodation with respect to these factors. As will be apparent, the T_{g} and T_{d} of the polymers selected for the present invention will again depend upon the particular application and the amount of heat that will be generated, but should, of course, be high enough that the polymer does not melt or degrade during use.

As will be apparent to those of ordinary skill in the art, these polymers do not, by themselves, have thermal conductivities high enough to make them very useful as heat dissipating materials. As set forth above, prior art systems address this by incorporating thermally conductive materials such as, metals, ceramics and carbon fillers into the polymer, which does significantly increase the thermal conductivity of the polymer. It also degrades the mechanical properties of the polymer composites, making them brittle, increases their weight, and makes them more difficult to fabricate, while also increasing their cost due to the need for expensive ceramic/carbon/metallic fillers. In various embodiments, the present invention avoids these problems by using supramolecular chemistry.

In one or more embodiments, the heat dissipating polymer composition of the present invention contains one or more self-assembling and self-aligning supramolecular filler materials. As set forth above, a supramolecule is the molecular cooperative assembly between complimentary molecules leading to spontaneous formation of stable aggregates with the presence of non-covalent interactions. As used herein, the terms “supramolecular material,” “supramolecular forming material” and “supramolecule forming compounds” are used interchangeably to refer to a material that alone or with other materials is capable of self-assembly into a supramolecule. Advantageously, at sufficient concentrations, these complementary materials will self-assemble into 2D structures which will also align without any external stimuli.

In various embodiments, any supramolecular material capable of self-assembly into substantially aligned 2D sheets within the selected polymer may be used. In some embodiments, the supramolecular filler material will comprise melamine and cyanuric acid. In some embodiments, the supramolecular filler material will comprise adenine and guanine, cytosine and guanine, or two or more ureidopyrimidinone derivatives. As will be apparent, the various component materials of a supramolecular material will be present in a molar ratio that permits self-assembly in to sheets. For example, melamine to cyanuric acid are known to assemble to form rosettes of three melamine molecules and three cyanuric acid molecules, which then organize into sheets. The melamine to cyanuric acid would therefore preferably be present in a molar ratio of about 1:1.

In one or more embodiments, the self-assembling and self-aligning supramolecular filler material comprises from about 5 wt % to about 80 wt % of said heat dissipating polymer composition. In some embodiments, the self-assembling and self-aligning supramolecular filler material comprises from about 5 wt % to about 80 wt %, in other embodiments, from about 10 wt % to about 80% wt, in other embodiments, from about 20 wt % to about 80% wt, in other embodiments, from about 30 wt % to about 80 wt %, in other embodiments, from about 40 wt % to about 50% wt, in other embodiments, from about 5 wt % to about 70 wt %, in other embodiments, from about 5 wt % to about 60 wt %, in other embodiments, from about 5 wt % to about 50 wt %, in other embodiments, from about 5 wt % to about 40 wt %, and in other embodiments, from about 5 wt % to about 30 wt % of said heat dissipating polymer composition. Here, as well as elsewhere in the specification and claims, individual range values can be combined to form additional non-disclosed ranges.

As set forth above, it has been found that the extensive network of multiple hydrogen bonds present in this supramolecular assembly, along with the aligned layered structure, facilitate efficient phonon transport, thereby improving the thermal conductivity (TC) of the polymer. In various embodiments, the heat dissipating polymer composition of the present invention will have a thermal conductivity of from about 0.3 W/m·K to about 1.0 W/m·K. In some embodiments, heat dissipating polymer composition of the present invention will have a thermal conductivity of from about 0.4 W/m·K to about 1.0 W/m·K, in other embodiments, from about 0.5 W/m·K to about 1.0 W/m·K, in other embodiments, from about 0.6 W/m·K to about 1.0 W/m·K, in other embodiments, from about 0.7 W/m·K to about 1.0 W/m·K, in other embodiments, from about 0.8 W/m·K to about 1.0 W/m·K, in other embodiments, from about 0.3 W/m·K to about 0.9 W/m·K, in other embodiments, from about 0.3 W/m·K to about 0.8 W/m·K, in other embodiments, from about 0.3 W/m·K to about 0.7 W/m·K, in other embodiments, from about 0.3 W/m·K to about 0.6 W/m·K, and in other embodiments, from about 0.3 W/m·K to about 0.5 W/m·K. Here, as well as elsewhere in the specification and claims, individual range values can be combined to form additional non-disclosed ranges.

In a second aspect, the present invention is directed to a heat dissipating polymer composite film comprising the heat dissipating polymer composition as described above. Advantageously, heat dissipating polymer composite films of the present invention can be formed in virtually any size, shape, or thickness. In various embodiments, the heat dissipating polymer composite film of the present invention will have a thickness of from about 10 microns to about 1 cm. Here, as well as elsewhere in the specification and claims, individual range values can be combined to form additional non-disclosed ranges.

The heat dissipating polymer composite films of the present invention can be made using any of the heat dissipating polymer composite materials described above. Accordingly, in various embodiments, these films will also have thermal conductivities of from about 0.3 W/m·K to about 1.0 W/m·K, depending upon the composition of the heat dissipating polymer composite material used. In various embodiments, heat dissipating polymer composite films of the present invention may have any of the thermal conductivities for the heat dissipating polymer composition described above.

In a third aspect, the present invention related to a method for making the heat dissipating polymer composite described above. One of the critical aspects of developing a robust polymer composite is the homogenous distribution of the filler. Processing methods can significantly alter the morphology and properties of the composites. In conventional mixing, filler powders are added into the polymer matrix and then depending on the processing steps, one can achieve different dispersion of fillers in matrix. Especially in the development of thermal conductive polymer composites, like those of the present invention, a closely connected thermal network is desired to acquire higher TC. Filler agglomeration is a critical problem in composites especially at high filler loadings. Advanced mixing instruments, optimized processing and long duration of mixing time are often required to achieve good dispersion.

To avoid these problems, the method of the present invention relies upon the creation of a solution containing the polymer and the supramolecular components that make up the filler. In this method, the polymer and each of the supramolecular components are dissolved separately and then combined to form a polymer/supramolecule solution. This method has several advantages. First, it allows each component to be dissolved in a way that is post appropriate for that component to insure that the component is fully dissolved. In some embodiments, each component solution is stirred until it is completely clear, indication that the component is fully dispersed in the solution. For example, polymers like polyvinyl alcohol must be heated above their glass transition temperature to dissolve in water. The component concentrations, stirring speeds, stirring times, temperatures and pressures, for example, can be tailored to ensure that the particular component is fully dissolved. Second, by making sure that each component is fully dissolved before they are combined, problems with filler agglomeration are largely eliminated. Third, because all of the component materials are already fully dispersed in their respective solutions, advanced mixing instruments, optimized processing and long duration of mixing time are not required to achieve good dispersion in the subsequent polymer/supramolecule solution. Moreover, it has been found that separately dissolving the supramolecular components allows for full dispersion of the supramolecular components and higher thermal conductivity. Finally, the fact that all of the components are dispersed in the polymer/supramolecule solution at a molecular level facilitates formation of the supramolecular 2D nanostructures with the polymer matrix as the solution cools and/or the solvent evaporates.

As will be apparent, all of the component solutions must be miscible with each other in order to form the polymer/supramolecule solution in which the supramolecular filler forms. The solvents used to form each one of these solutions will, of course, depend upon the particular components chosen. If possible, however, it is preferred that a single solvent be used for all of the components, but this is not required. In some embodiments, all of the components will be soluble in a single solvent. For example, in some embodiments, the polymer and supramolecular components are all water soluble and the solvent used will be deionized water. Is some other embodiments, different solvents or solvent combinations may be used to dissolve the various components and then mixed together to form the polymer/supramolecule solution. As will be appreciated, all of the components in these embodiments must be soluble in the solvent combination formed when the different component solutions are mixed and remain so for at least long enough to allow the supramolecular components to self-assemble to form 2D nanostructures, as described above. One of ordinary skill in the art will be able to select suitable solvents for the component solutions without undue experimentation.

In some embodiments, a suitable polymer, as described above, is selected according to the intended application. As set forth above, for applications where the heat dissipating polymer composition of the present invention will be used in connection with a computer or other electrical or electronic device, use of a substantially electrically non-conductive polymer to form the matrix of the material is strongly preferred to prevent short circuits of the electronic device through the heat dissipating polymer composition, but not absolutely required. In one or more embodiments, suitable polymers may include, without limitation, poly(vinyl alcohol), polyvinyl propylene, polyamides, polyacrylic amides, polysaccharides, polyacrylic acids, polyurethanes with polyethylene glycol ether soft segments, or various combinations, copolymers and grafts thereof. In various embodiments, the polymer selected will be a substantially electrically non-conductive polymer. In some embodiments, the substantially electrically non-conductive polymer is poly(vinyl alcohol). In some other embodiments, the substantially electrically non-conductive polymer is polyvinyl propylene.

The selected polymer is then dissolved in a suitable solvent under suitable conditions until the polymer solution is fully dissolved. In one or more embodiments, the polymer is dissolved in the solvent under constant stirring or mixing. The polymer solution may be stirred using any conventional method. In some embodiments, the polymer solution may be stirred using a magnetic stirring rod. In some other embodiments, the polymer solution may be stirred using any one of the many mechanical stirring devices known for that purpose. In some embodiments, increased temperatures and pressures may be used to increase solubility of the polymer chosen in a particular solvent. Further, as set forth above, some polymers like polyvinyl alcohol (PVA) must be heated above their glass transition temperature to be dissolved. In some of these embodiments, a PVA is dissolved in deionized (DI) water at a temperature of from about 90° C. to about 95° C. under magnetic stirring for 4 to 6 hours or until the solution becomes clear indicating that the PVA has been fully dissolved and dispersed within the water.

The concentration of the polymer solution is not particularly limited and will depend, among other things, on the solubility of the polymer in the solvent or solvent combination under the reaction conditions being used. In some embodiments, the polymer solution will be a 7% aqueous solution of PVA by weight.

Next, the supramolecular forming components, as described above, are selected and then quantities of these materials needed for supramolecule formation are separately dissolved in suitable solvents, as described above. In various embodiments, any combination of materials known to self-assemble to form supramolecules that organize into aligned structures, particularly 2D nanosheets, may be used, provided that they are compatible with the selected polymer. As used herein, a supramolecular forming component will be understood to be “compatible” with the selected polymer if it is non-reactive with the polymer. In various embodiments, any of the supramolecular forming components described above may be used, depending upon the polymer chosen. In some of these embodiments, the polymer is PVA and the supramolecular forming components are melamine and cyanuric acid. Further, in these embodiments, the molar ratio melamine to cyanuric acid will be 1:1, since that is the molar ration at which it forms supramolecules.

As with the polymer solution described above, each of the supramolecular forming components must be fully dissolved. In one or more embodiments, each one of the supramolecular forming components is dissolved in a suitable solvent under constant stirring until all of the supramolecular forming component in dissolved and dispersed within the solvent. Further, each one of the supramolecular forming components is dissolved separately. As will be apparent, dissolving the supramolecular forming components separately allows each supramolecular component to be fully dispersed in the polymer solution before any significant supramolecular formation can take place and largely eliminates problems with filler agglomeration. Moreover, separately dissolving the supramolecular forming components also provides flexibility in determining the amounts of solvents and temperatures necessary for forming the solutions. As with the polymer solutions, it may be necessary in some embodiments of the present invention to dissolve the supramolecular forming components at an elevated temperature. As sued herein, the term “elevated temperature” refers to a temperature that has been raised above the ambient or room temperature. In some of these embodiments, for example, required amount of melamine and cyanuric acid are separately dissolved in DI water at 90° C. under constant magnetic stirring.

The solvents used to dissolve the supramolecular forming components are preferably the same solvent of solvent mixture used to dissolve the polymer, but as set forth above, this need not be the case. In any event, the solvents should be miscible with each other at the relevant temperatures and the polymer and all of the supramolecular forming components must be soluble in the combined solvents for at least long enough to allow the supramolecular components to self-assemble to form 2D nanostructures, as described above.

The supramolecular components solutions are then added to the polymer solution to form a polymer/supramolecule solution, which is mixed until the polymer and supramolecular components are fully dispersed throughout the solution. In some embodiments, the supramolecular components solutions are added to the polymer solution one at a time, but this need not be the case. In some embodiments, the polymer/supramolecule solution will become clear when the supramolecular components are fully dispersed throughout the solution.

The polymer/supramolecule solution is them stirred, mixed or agitated for sufficient time to ensure that the polymer and the supramolecule components are fully dispersed in the solution. The polymer/supramolecule solution may be stirred, mixed or agitated using any conventional method. In some embodiments, the polymer/supramolecule solution may be stirred using a magnetic stirring rod. In some other embodiments, the polymer/supramolecule solution may be stirred using any one of the many mechanical stirring devices known for that purpose. In some embodiments, the polymer/supramolecule solution is stirred for 10 min to about 5 hours. Here, as well as elsewhere in the specification and claims, individual range values can be combined to form additional non-disclosed ranges.

In one or more of these embodiments, the polymer/supramolecule solution is stirred at an elevated temperature. In some of these embodiments, the polymer/supramolecule solution is stirred at a temperature of from about from 25° C. to about 90° C. As will be apparent, the polymer/supramolecule solution should not be heated to a temperature that would damage the structure of the polymer or damaging the supramolecular components is such a way as to prevent them from forming supramolecules of 2D nanosheets.

Finally, the solvent is removed to produce the heat dissipating polymer composition of the present invention. As the solvents evaporate or are otherwise removed, the concentrations of the supramolecular components in the solution increases bringing them into closer contact with each other and facilitating their formation into supramolecules and organization into 2D nanosheets. Finally, the polymer will gradually come out of solution and harden to produce heat dissipating polymer composition of the present invention. The time this takes will depend upon such things as the particular solvents used, the solvent concentrations, the speed of supramolecule formation, and the speed of 2D nanosheet formation, among others. As will be apparent, the solvent should not be removed so quickly that the polymer solidifies before the 2D nanosheets have time to form. In some embodiments, the solvent may be removed by evaporation at ambient temperature. In some other embodiments, the solvent may be removed at an elevated temperature. In some other embodiments, the solvent may be removed at a reduced pressure. In some of these embodiments, the solvent is slowly removed by heating to a temperature of from 30° C. to 70° C. for from about 1 to about 7 days at ambient pressure or until the polymer has fully hardened. In some embodiments, the solvent is slowly removed by heating to a temperature of from 30° C. to 70° C., in other embodiments, from 40° C. to 70° C., in other embodiments, from 50° C. to 70° C., in other embodiments, from 30° C. to 60° C., in other embodiments, from 30° C. to 50° C., and in other embodiments, from 30° C. to 40° C. Here, as well as elsewhere in the specification and claims, individual range values can be combined to form additional non-disclosed ranges.

In a fourth aspect, the present invention related to a method for making the heat dissipating polymer composite films described above. In these embodiments, the polymer/supramolecule solution is stirred to insure the polymer and supramolecule components are fully dispersed and then poured into a flat-bottomed container or onto a surface and slowly removing the solvent, as described above. In some embodiments, the solvent is removed by evaporation it at a temperature of from about 25° C. to about 70° C. for from 1 to 7 days to form a freestanding film. As will be apparent, care should be taken not to remove the solvent too quickly as large amounts of solvent quickly leaving the hardening material can damage the forming film.

In some embodiments, the fully formed films may be reheated to a temperature of from 40° C. to about 80° C. for from 1 to 48 hours to remove any remaining solvent. In some of these embodiments, the fully formed films may be reheated to a temperature of about 60° C. for from 1 to 48 hours to remove any remaining solvent. Here, as well as elsewhere in the specification and claims, individual range values can be combined to form additional non-disclosed ranges.

To further evaluate the heat dissipating polymer composite materials of the present invention and further reduce them to practice, a series of a series of heat dissipating polymer composite materials comprising a polyvinyl alcohol (PVA) polymer and melamine and cyanuric acid as the supramolecule forming compounds were formed and characterized. A solvent casting method was used to prepare the various heat dissipating polymer composite films tested. The required amount of PVA was first dissolved in DI water at 90-95° C. under magnetic stirring for 5 hours to make a clear 7% aq. PVA solution under constant magnetic stirring. The required amounts of M and C were then separately dissolved in DI water at 90° C. under constant magnetic stirring until completely dissolved (both individual solutions turn transparent after complete dissolution). The melamine (M) and cyanuric acid (C) were dissolved in deionized (DI) water such that their molar ratios were 1:1 and accordingly their weight percentage was calculated for composite films. Then both these transparent solutions were then poured one by one into PVA solution under magnetic stirring for 3 hours at 80-85° C. After obtaining clear aqueous PVA solution, it was poured in glass petri dish and dried at 35° C. for 4 days to obtain freestanding films and later heated at 80° C. for another 1 day to for a film. The same process was followed as for Pure PVA free standing films, but the melamine (M) and cyanuric acid (C) were left out.

The terms “MC” and “CM” are used herein to refer to the melamine cyanurate filler formed by supramolecular assembly of the melamine (M) and cyanuric acid (C), where the order of the C and M reflect the order of addition of these compounds into the PVA polymer. Accordingly, the term MC-X is used herein to refer to a polymer composite film with X wt % loading of MC where the aqueous melamine (M) solution is added to the PVA solution before the aqueous cyanuric acid (C) solution and, conversely, the term “CM-X” refers to a polymer composite film with X wt % loading where the aqueous cyanuric acid (C) solution is added to the PVA solution before the aqueous melamine (M) solution. Further, the term “MC-P-X” is used herein to represents composite films with X wt % loading of MC prepared by mixing dry powder of MC into PVA solution. For comparison purpose, PVA/Melamine and PVA/Cyanuric acid composite films were also prepared which are named as M-X and C-X respectively, where X, again, refers to the wt % loading of the M or C. respectively.

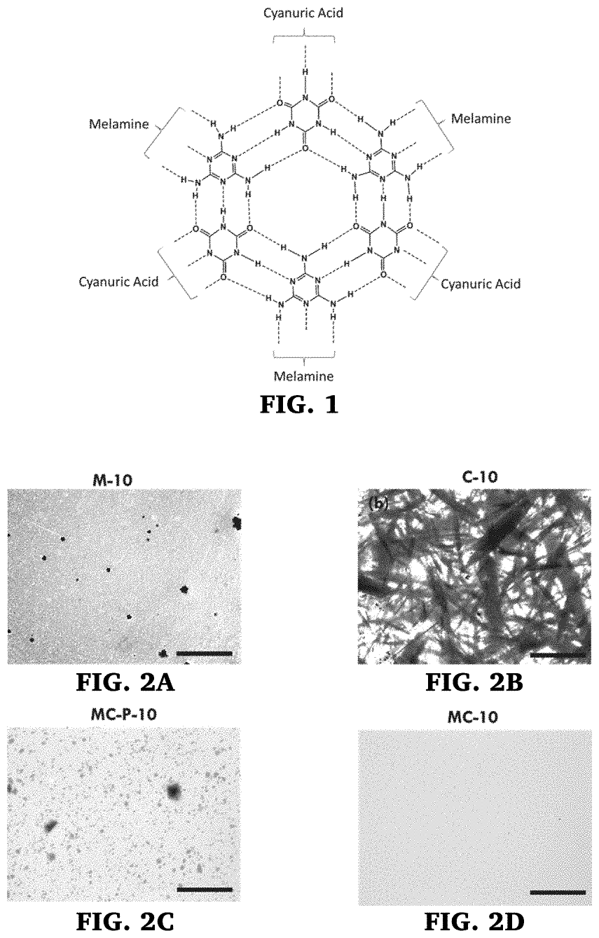

Scheme of hydrogen bonding showing molecular assembly of MC is shown in FIG. 1. As can be seen, multiple hydrogen bonding linkages of N—H—O and N—H—N can be formed between melamine and cyanuric acid in the assembled crystal structure. Lattice of MC is quite stable and can sustain temperatures of up to 350° C. without decomposition due to the large bonding energy (as high as 7 kcal/mol) derived from the nine hydrogen bonds formed with neighboring molecules. This hydrogen bonding pattern has a hexagonal symmetry due to the complementary nature melamine and cyanuric acid molecules. It is believed that this type of supramolecular assembly provides good handle to engineer intermolecular interaction with the surrounding polymers and create pathways for efficient phonon transport through hydrogen bonding interactions.

As set forth above, one critical aspect of developing a robust polymer composite is the homogenous distribution of the filler in the polymer. The in-situ co-precipitation method used to form the heat dissipating polymer composite materials tested achieved excellent dispersion of the MC filler in the PVA polymer. As set forth above, the M and C were dissolved in water separately and then poured into PVA aq. solution one by one under mixing, which leads to a homogenous dispersion of MC filler. Because the M and C form multiple hydrogen bonded supramolecular structure by co-precipitation, this method was found to prevent filler agglomeration in the polymer matrix. The method also provided an effective approach to precipitate fillers in the matrix and develop a well-developed thermal network.

FIGS. 2A-D presents optical microscopy images of composite films of M-10 (FIG. 2A), C-10 (FIG. 2B), MC-P-10 (FIG. 2C) and MC-10 (FIG. 2D), respectively. As can be seen, the M-10 and C-10 have crystals of melamine and cyanuric acid distributed in the composite film. The black dots in M-10 (FIG. 2A) are the discrete agglomeration of melamine crystals. C-10 shows big needle like crystals those are randomly distributed in polymer matrix (FIG. 2B). Although it has been revealed that crystals in the polymer can significantly influence its overall TC, it is believed that the distribution of such crystals and their shape have a dominating role in the transport of phonons. FIGS. 2C-D show the impact of mixing and the resultant distribution of fillers in polymer matrix. As is shown in FIG. 2C, the MC-P-10 forms both small and large aggregates, which shows a lack of uniform dispersion. The MC-10, on the other hand (see, FIG. 2D), displays a very fine dispersion without aggregates. Advantageously, it has been found that in-situ precipitating MC in the PVA solution results in excellent dispersion of fine crystals throughout the matrix, significantly reducing the amount of aggregation compared to traditional mixing. It is believed that this homogenous distribution of fillers can have a significant impact on the thermal conduction of polymer composites, as it leads to efficient development of continuous thermal networks.

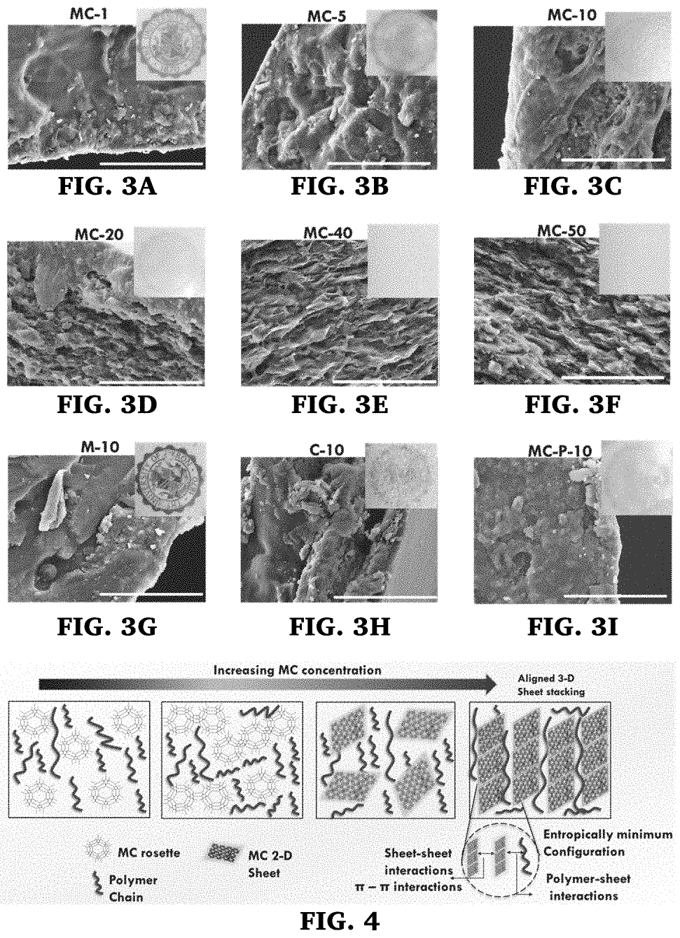

To better understand the morphology of the heat dissipating polymer composite films tested, cross-sections of these composite films were probed by SEM. FIGS. 3A-I presents the SEM images of MC-1 (FIG. 3A), MC-5 (FIG. 3B), MC-10 (FIG. 3C), MC-20 (FIG. 3D), MC-40 (FIG. 3E), MC-50 (FIG. 3F), along with M-10 (FIG. 3G), C-10 (FIG. 3H) and MC-P-10 (FIG. 3I). The upper right corner of each image shows their respective photos with the film on top of the University of Akron logo, indicating the optical transparency of each film. From MC-1 to MC-10 (FIGS. 3A-F), the cross-sectional morphology is about the same as would be expected for MC randomly distributed in the PVA matrix. Further increasing the MC loading in the composites leads to an obvious layered structure in MC-20, MC-40 and MC-50 (see, FIGS. 3D-F). As expected, there were no significant features found in the SEM cross-sections of M-10, C-10 and MC-P-10 (FIGS. 3G-I).

While not wishing to be bound by theory, it is believed that the aligned planer sheet structure found at higher loading of MC was the result of the stacking of several MC rosettes or 2-D hexamer sheets of MC and intermolecular interactions between the MC and the polymer matrix. In case of a single crystal of MC, it had been shown through single-crystal X-ray diffractometer that MC hexamers are 2-D planer sheet and these sheets are stacked to give a 3-D structure. See, e.g., Ranganathan, A.; Pedireddi, V. R.; Rao, C. N. R. Hydrothermal Synthesis of Organic Channel Structures: 1:1 Hydrogen-Bonded Adducts of Melamine with Cyanuric and Trithiocyanuric Acids. J. Am. Chem. Soc. 1999, 121 (8), 1752-1753, the disclosure of which is incorporated herein by reference. At higher loading of MC in PVA, this is more pronounced as several sheets can form this self-aligned planer structure. Moreover, formation of such structure may also be facilitated due to the in-situ precipitation of MC in polymer matrix, since MC particles are very fine and a higher loading can lead to the formation of these 2D sheet structures.

The non-covalent assembling of molecules follows the principal of thermodynamic minima at equilibrium state. As set forth above, the MC in some or all of the composite films tested are arranged to form a rosette structure with three molecules of each M and C through intermolecular hydrogen bonding. The total of six molecules leads to a thermodynamically stable structure (see, FIG. 1), as any more or less molecules will result in entropically unfavorable configuration. Several rosette combinations can result in 2-D sheet structure where C and M are held together by N—H . . . O and N—H . . . N hydrogen bonding interactions. As the water evaporates, the increasing concentration leads to an increase in contact surfaces and as the M and C molecules come together MC rosettes will be formed and ultimately several of these MC rosettes will come together to form 2-D planer sheets. The arrangement of these sheets during crystallization inside the polymer depends on a variety of factors including, but not limited to, the polymer concentration, thermodynamic equilibrium states, and the interactions between the polymer and organic molecules. As will be apparent, in the self-assembly of M and C the reversible interactions of hydrogen bonding will lead to formation of final structure representing the thermodynamic minimum. In order to achieve a layered structure with stacking of 2-D sheets, the forces between polymer and sheets and inter-sheets should be balanced as crystallization process proceeds (FIG. 4). Among the 2-D sheets of MC, there exist π-π interactions which can lead to its stacking. At relatively low MC concentration of less than 20 wt %, such stacking was not observed since not enough 2-D sheets were available to form good intermolecular contact. As MC concentration further increased, however, 2-D sheets become aligned and stacked in parallel as can be seen in FIGS. 3A-F and 4. The sheet-sheet forces and polymer-sheet forces need to be balanced to reach a well-defined 3-D stacking arrangement possessing an entropically favorable configuration.

These self-assembled layered structures were found to be highly beneficial for enhancing TC in composites. PVA with high density of —OH groups and presence of rich hydrogen bonding groups in M and C in the heat dissipating polymer composite materials tested can be expected to provide a driving force to facilitate such equilibrium structure and thermodynamic minimum state. Here PVA's intermolecular interactions with the 2-D sheets are not competitive, as that might disturb the balance between entropy and enthalpy, making formation of such stacked 3-D equilibrium structures more unlikely. Though the fundamental mechanism of self-assembly of MC in composites remains unclear, the control of supramolecular assembly and subsequent structural patterning in polymer composites has been shown to be useful in fabricating functional composites.

In the heat dissipating polymer composite materials tested, the PVA polymer was located between the planar MC sheets behaving like a bonding layer. With sufficient interactions in the interfacial bonding layer, the thermal resistance between the planar MC sheets were expected to be decreased. In fact, both PVA-MC hydrogen bonding and MC-MC π-π interaction facilitate the formation of strong interfacial interactions. In particular, the π-π interaction became obvious at MC loading above 20 wt % where there was planar stacking of 2D sheets.

To analyze crystal structure of the composites, X-ray diffraction (XRD) analysis was done on PVA, MC powder, and MC-5, MC-10, and MC-50 composites using a Bruker AXS D8 Discover diffractometer with GADDS (General Area Detector Diffraction System) operating with a Cu—K α radiation source filtered with a graphite monochromator (λ=1.541 Å). (See, FIG. 5) PVA is a semi-crystalline polymer with a relatively high density of —OH groups. Crystalline nature of PVA comes from the abundant inter/intra hydrogen bonding between —OH groups. FIG. 5 shows XRD diffraction peaks of PVA, MC powder and various PVA-MC composites. The signature peak of PVA at 19.56° results from its intra/intermolecular hydrogen bonding interactions and corresponds to (101) crystal plane. For the MC powder, two intense peaks were found at 28.16° and 11.04°, corresponding to its (002) and (100) crystal planes. The crystalline lattice of the MC composites was different from that of PVA and MC powder as peaks from both PVA and MC powder were seen. As seen in FIG. 5, signature peak of PVA gradually decreases and new peaks of MC become more intense with an increase in MC loading. Three prominent peaks of MC powder around 11.04°, 12.08° and 28.16° were found in the PVA/MC composites. The intensity of these peaks was found to gradually increase from MC-5 to MC-50. The intense peak at 28.16° can be assigned to the 2-D stacking of individual MC sheets, as seen from the SEM. The presence of such a strong peak implies a highly ordered stacking structure, via a combination of intermolecular interactions within the polymer chains and MC sheets while reaching an entropically favorable configuration. It is believed that such changes in crystalline lattice of polymer composite and formation of stacked layers are of great significance and can have significant impact on the ability of transferring thermal phonons. In past study of nacre inspired design where external forces have been employed to develop aligned layered structure in polymer composite, good orientation of the crystalline regions had helped in directing phonon transport. Similarly, stacking of polymer composites layers through hot press and carbonization has led to enhanced TC. Therefore, self-assembly of aligned 2-D stacked layers as presented in this study provides indeed an alternating yet promising route to achieve enhanced TC in polymer composites.

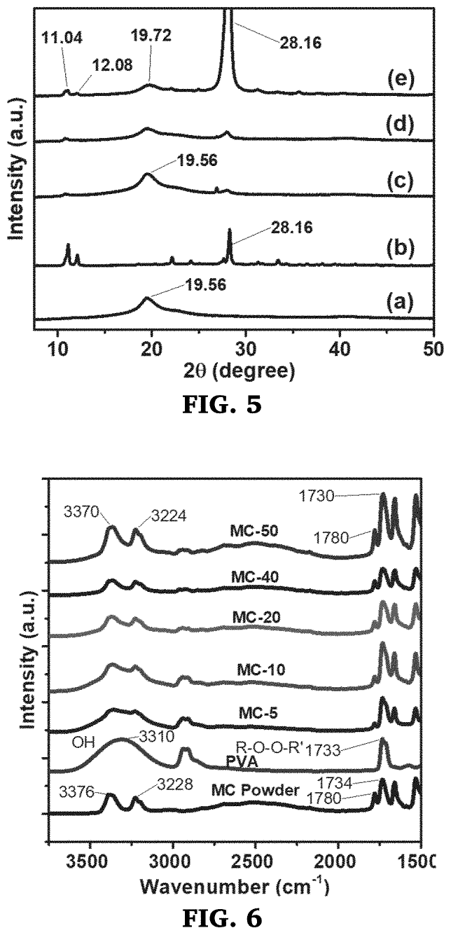

To probe in the intermolecular interaction between polymer matrix and MC, FT-IR was carried out was carried out by using Perkin Elmer Frontier FT-IR spectrometer. (see, FIG. 6) The solid-state ¹H spin-lattice (T₁) relaxation values were measured using an inversion recovery sequence (delay-π-τ-π/2) followed by cross-polarization to ¹³C for detection with a 4 mm T3HXY MAS probe on an Agilent NMRS 500 MHz instrument operating at 11.7 T. Generally, changes in intermolecular interaction can have significant influence on both chemical and physical properties of polymers. Specifically, given the presence of abundant —OH groups in PVA and rich hydrogen bonding groups in MC, inter/intra hydrogen bonding formation could be expected between MC and PVA matrix, through which the phonon propagation can be engineered by the hydrogen bonding network within MC and across MC-PVA interface.

As will be understood by those of skill in the art, pure PVA has a characteristic —OH peak at 3300 cm⁻¹ and one at 1733 cm⁻¹ that corresponds to acetyl acetate group. The peak at 2925 cm⁻¹ is understood to be from the C—H stretching. Addition of MC in the PVA leads to the formation of several intermolecular interactions due to the presence of —COOH, —NH₂, and —OH groups. In MC powder, peaks at 3376 and 3228 cm⁻¹ correspond to the stretching vibrations of amino groups while peaks at 1780 and 1734 cm⁻¹ are from the vibration of the triazine ring. The characteristic —OH peak gradually shifted to lower wave number as the increase of MC loading, indicating the strengthening of intermolecular interaction. The enhancement of such intermolecular interactions can be beneficial for creating new pathways to drive phonon transportation.

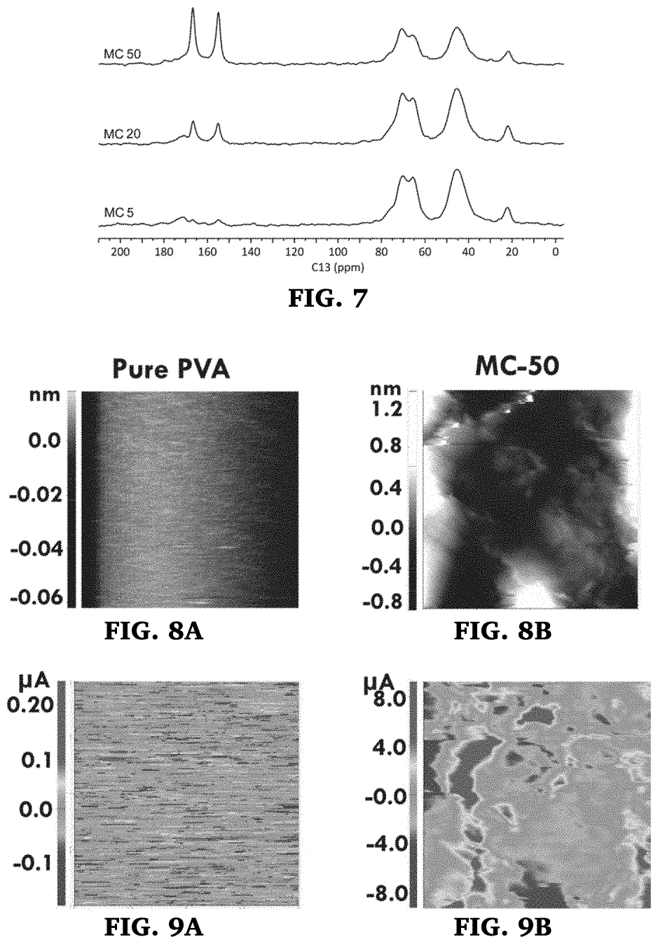

NMR was further employed to probe into molecular chains arrangement and intermolecular interactions in three PVA-MC composites (see, FIG. 7). ¹H spin-lattice (T₁) NMR relaxation time values were measured for the MC-5, MC-20 and MC-50 using an inversion recovery sequence followed by cross-polarization to ¹³C for detection. This experiment was chosen to take advantage of the shorter T₁ values and experimental time of ¹H while maintaining the higher resolution of ¹³C spectra. The resolvable peaks are listed in Table 1, below.

TABLE 1
Measured ¹H T₁ relaxation time of PVA and
MC in different loading of composites.

| | ¹³C Peak | MC-5 ¹H T₁ | MC-20 ¹H T₁ | MC-50 ¹H T₁ |
|---|---|---|---|---|
| Compound | (ppm) | (s) | (s) | (s) |
| MC | 167 | 7.22 ± 0.48 | 8.92 ± 0.66 | 10.54 ± 0.25 |
| | 155 | 8.40 ± 0.56 | 9.49 ± 0.85 | 10.53 ± 0.30 |
| PVA | 70 | 8.19 ± 0.41 | 8.57 ± 0.36 | 8.68 ± 0.61 |
| | 66 | 7.85 ± 0.23 | 8.57 ± 0.30 | 8.66 ± 0.74 |
| | 46 | 8.00 ± 0.33 | 9.04 ± 0.37 | 8.50 ± 0.53 |
| | 22 | 7.03 ± 0.45 | 9.54 ± 0.72 | 9.79 ± 0.76 |

Melamine (167 ppm) shows a lower ¹H T₁ value in the MC-5 sample compared to cyanuric acid (155 ppm) due to the increased mobility of the amine groups in addition to molecular tumbling. The ¹H T₁ values of melamine and cyanuric acid increase with increased concentration. At MC-50, melamine and cyanuric acid have about equal T₁ values, which suggests most of the material has formed the 1:1 MC hydrogen-bonding complex. Once MC is paired through hydrogen bonding, its molecular motion is restricted to the molecular tumbling of the whole MC complex and thus the relaxation time for the two molecules is expected to be similar. The methine (66-70 ppm) and methylene (46 ppm) groups of PVA do not show a significant change in ¹H T₁ due to the lack of binding of the polymer backbone. However, the methyl group (22 ppm) does show an increase in T₁ relaxation time, which indicates restricted motion of the acetyl side group at higher MC concentrations. This suggests an ordering or stacking of polymer chains which gives a further confirmation of the impact of MC in controlling the composite's micro-morphology as its loading increases.

FIGS. 8A-B and 9A-B present the topography (FIGS. 8A-B) and Scanning Thermal Microscopy (SThM) images (FIGS. 9A-B) of pure PVA and MC-50. The SThM images were taken using a Scanning Thermal Microscopy (SThM) (Park XE7-AFM with thermal module). SThM can provide thermal mapping of the samples while simultaneously running topography, which is especially useful to map thermal interfaces and develop correlation with the topography images. Here, a probe tip was used as resistive heating element to transfer heat to the sample which is controlled by a Wheatstone bridge. Probe current can be used to correlate the TC as released current is proportional to the TC of the point of contact. In topography images (FIG. 8A) and SThM image (FIG. 9A) of pure PVA, no specific patterns were obtained due to the homogeneous nature of the film. In topography image of MC-50 (FIG. 8B), inhomogeneous feature is found due to the presence of fillers. The brighter areas are corresponding to the filler while the rest is polymer. As can be seen in corresponding SThM (FIG. 9B), regions of higher and lower probe current or TC represented by red and blue color respectively are present in the sample. It is worth noting that in most of the scanned areas, interfaces are featured with relatively higher TC (red color). This probably shows the impact of strong MC-PVA interface in strengthening the interfacial thermal conductance. Such strong interfacial interaction is supported by the FT-IR results in earlier discussion, and it is critical to promote phonon transport across composite interface where most of the phonon scattering takes place in traditional composites.

As discussed above, the MC filler comes with multiple hydrogen bonding functional groups which can lead to change of intermolecular interactions and perhaps help in improving the interfaces formed in the PVA matrix. Such decrease in interfacial resistance is important to facilitate efficient transport of phonon especially in polymer composite where most of the phonon scattering takes place at composite interfaces.

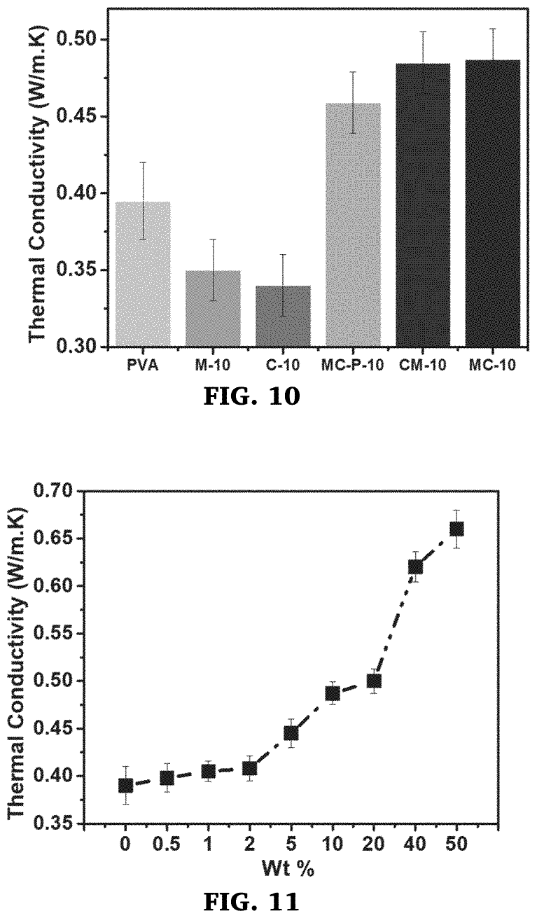

FIG. 10 presents the TC of composite samples at 10 wt % loading. Due to chain entanglements, voids, and other issues, the bulk PVA polymer has pronounced phonon scattering that renders them thermal insulators. TC of pure PVA was found to be around 0.40 W/m·K. After the incorporation of either melamine or cyanuric acid, the TC decreased to ˜0.35 W/m·K. The addition of MC increased the TC to 0.49 W/m·K at 10 wt % loading. It is interesting to note that TC of MC-10 is higher than that of both M-10 and C-10. Further, optical microscopy images of both M-10 and C-10 showed that the fillers were not homogenously distributed. In M-10 there were several big and small crystals of melamine and in C-10 there were randomly ordered spikes of cyanuric acid. Both were found to negatively impact thermal conductivity leading to enhanced phonon scattering. By using different mixing procedures, however, the TC of MC-P-10 acquires a lower TC value of 0.46 compared to MC-10. In case of MC-10, a homogenous distribution of the filler was achieved with enhanced filler-filler connection, thereby generating an efficient pathway for phonon transport.

To further investigate the processing factor, the sequence of melamine solution and cyanuric acid solution addition was reversed and the composite was named CM-10. No substantial difference was found in the TC of CM-10 and MC-10, which indicates that the thermal conductivity is independent of the order in which aqueous solution of individual component is mixed and, instead, depends on the filler as a whole and PVA matrix alone.

One of the objectives to have a comparative study of TC by incorporating individual fillers of melamine and cyanuric acid was to shed light on the impact of multiple hydrogen bonding supramolecular fillers in enhancing TC. Such supramolecular filler in a polymer matrix like PVA, can be thought of leading to the formation of multiple “thermal bridges” which act as a thermally conductive filler responsible for efficient thermal conduction. Noting the decrease of TC in M-10 and C-10 after incorporating individual components, the TC enhancement achieved by MC filler demonstrates the capability of such supramolecular assembled structures in improving thermal conduction.

To further study the loading effect of MC in PVA composites, MC loading was adjusted in a wide range from 0.5 to 50 wt %. FIG. 11 shows the TC as a function of MC loading. Obviously, TC gradually increases with the increase of MC loading up to 50 wt %. It can be seen that thermal conductivity gradually increases to 0.66 W/m·K at 50 wt % loading. In PVA/MC composites, before the onset of layered sheet structure at 20 wt % MC loading, MC-10 achieved relatively higher TC than neat PVA. This result indicates that TC of PVA-MC composite benefits from factors like its ability to form multiple hydrogen bonds and favorable crystalline lattice in addition to good mixing. As can be seen from the FIG. 11, the TC at 10 and 20 wt % is quite similar and gradually increases at higher loading after the formation of 2-D aligned sheet structures. With the increase of MC loading, the number of “thermal bridges” increases and hence the ability to transport phonon. SThM results reveal that the composite interface strengthens, which lowers phonon scattering and positively contributes to the thermal conduction across interface. Both changes in intermolecular interaction and stacking pattern of crystal sheets can greatly impact thermal conduction. More specifically, a boost to the thermal conduction of composite is provided at the MC loading of 20 wt % and above, which is attributed to the combined impact of increased number of thermal pathways formed due to increase of MC loading and more specifically to the onset of self-aligned 2-D sheet structure. This is evident from the SEM where inception of layered structure was seen from MC-20, FIG. 3. These layered structures have significant positive contribution to the TC especially at the higher loading of MC in PVA matrix.

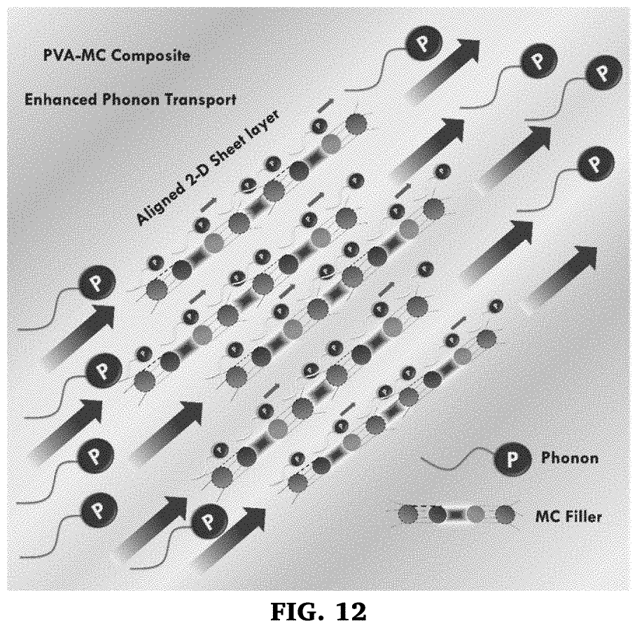

FIG. 12 schematically illustrates the phonon transport in MC composite through 2-D layered sheets together with strengthened interfaces. Both inter-/intra-molecular hydrogen bonding and sheet morphology of MC can have significant impacts on the thermal conduction of the composite films. Firstly, the rich hydrogen bonding in the composites serves as phonon transport pathways and contributes to the enhanced heat conduction; secondly, aligned MC sheets facilitate in-plane phonon transport and reduce phonon scattering. At lower MC loading, TC gradually increases and reaches a plateau region between 10-20 wt %. Beyond 20 wt % loading, MC molecule assembles into sheet structure and TC enhancement becomes more pronounced. Strong hydrogen bonding interaction between PVA and MC sheets can be expected due to the presence of high density —OH groups in PVA and rich hydrogen bonding sites in MC. At higher MC loading, the MC crystal grows into a thermodynamic stable configuration and forms aligned sheet structures, which provides excellent phonon pathways and thus positively contributed to the overall TC. External stimuli like electrical and magnetic forces have been used to enforce filler alignment, while in the present invention the aligned sheet structure is achieved by the virtue of the intrinsic properties of MC. Overall, it can be seen that several factors are responsible to control the effective TC of PVA/MC composite like changes in intermolecular interactions, 2-D layered sheet structure, composite interfaces and mixing of fillers. The interplay of all these factors governs the overall TC of the composites.

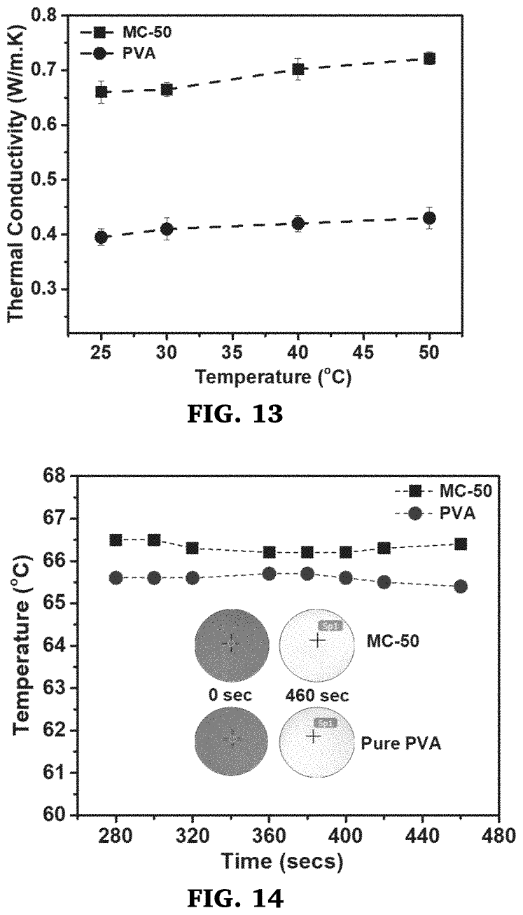

FIG. 13 shows the variation of TC within the temperature range of 25-50° C. as a function of temperature. Increasing the temperature from 25 to 50° C., TC of PVA increases from 0.40 to 0.43 W/m·K while MC-50 increases from 0.66 to 0.72 W/m·K. The change in TC for MC-50 is almost twice the value of pure PVA. Usually with the increase of temperature, TC is assumed to be affected by two competing factors: One is the positive influence of increment of specific heat with increase of temperature; the other is the negative influence of decrease of mean free path. As the TC increases, it could be assumed that positive influence of specific heat is more pronounce in determining the overall TC in both PVA and composite. The change in thermal conductivity for MC-50 is almost 20 times the pure PVA over temperature. Such increase in TC could also be seen as a positive feature in employing polymers for thermal management. As the surrounding temperature increases, such polymer-based materials could more effectively dissipate heat as their TC increases.

To further probe their thermal management capability, heat dissipation test was carried out by using FLIR thermal camera, FIG. 14. Samples with similar thickness were heated with a hot plate and the top surface temperature was monitored over time at steady state. The FUR images for pure PVA and MC-50 are shown as the inset of FIG. 14 at 0 and 460 secs. Materials with higher TC are able to conduct heat more efficiently and achieve higher surface temperature. Higher equilibrium temperature can be reached with MC-50 than that of pure PVA.

TABLE 2
Effective TC of MC composite compared with literature reports.

| | Filler | Loading | | Matrix | Composite | RoM^{b} | % |
|---|---|---|---|---|---|---|---|
| Filler | TC^{a} | (wt %) | Matrix | TC | TC | TC | Effectiveness^{c} |
| AlN | 160 | 25 (vol) | PP | 0.113 | 0.638 | 40.10 | 1.6 |
| SiC | 300 | 3 | Epoxy | 0.2 | 0.45 | 9.20 | 4.9 |
| Si₃N₄ | 200 | 22 (vol) | Epoxy | 0.2 | 3.9 | 44.16 | 8.83 |
| BN | 330 | 15 | PVA | 0.18 | 0.8 | 49.65 | 1.61 |
| Graphene | 750 | 25 | Epoxy | 0.2 | 12.4 | 187 | 6.6 |
| MWNT | 750 | 2 | PC^{d} | 0.21 | 0.32 | 15.2 | 2.1 |
| MC | 0.95 | 10 | PVA | 0.4 | 0.49 | 0.45 | 108 |
| | | 50 | | 0.4 | 0.66 | 0.65 | 98 |

All TC are cross plane values in W/m · K.
^{a}Filler values are taken from Mehra, N.; Mu, L.; Ji, T.; Yang, X.; Kong, J.; Gu, J.; Zhu, J. Thermal Transport in Polymeric Materials and Across Composite Interfaces. Appl. Mater. Today 2018, 12, 92-130, the disclosure of which is incorporated herein by reference. TC of boron nitride is given a lower limit of 330 W/m · K and similarly TC of graphene/MWNT is assumed to be 750 W/m · K.
^{b}RoM = Rule of Mixing (weighted average TC)
^{c}% Effectiveness = [Composite TC/RoM TC] * 100
^{d}PC: Polycarbonate

As can be seen from Table 2, the effective TC of polymer composite achieved by conventional fillers could hardly achieve 10% of theoretical rule of mixing value (% Effectiveness) whereas the TC of MC composite could surpass 100%. There is a substantial difference in the composite TC and RoM TC in conventional polymer composites is the result of the massive phonon scattering present in these systems. Channelizing the phonons without getting it scattered is therefore the key in the development of advanced thermally conductive composites. In MC-10 and MC-50, both at low and high loadings, full realization of TC of filler was found in the resultant polymer composites. This is due to the combined impact of various factors as discussed previously such as self-assembled layered structure, enhanced intermolecular interactions, strengthened interfaces and effective mixing. MC composite therefore paves the way for a new strategy to efficiently channelize phonons and maximize the TC in resultant polymer composites.

FT-IR characterization was carried out by using Perkin Elmer Frontier FT-IR spectrometer. Solid-state ¹H spin-lattice (T₁) relaxation values were measured using an inversion recovery sequence (delay-π-τ-π/2) followed by cross-polarization to ¹³C for detection with a 4 mm T3HXY MAS probe on an Agilent NMRS 500 MHz instrument operating at 11.7 T. Optical Microscopy of the composite film was characterized by benchtop AMG EVOSX1 while SEM was done using Hitachi TM3030. The X-ray diffraction analysis was performed with a Bruker AXS D8 Discover diffractometer with GADDS (General Area Detector Diffraction System) operating with a Cu—K α radiation source filtered with a graphite monochromator (λ=1.541 Å). Cross-plane TC measurements were made using C-Therm TCi TC Analyzer. The TCi works on modified transient plane source technique (Conforms to ASTM D7984) and its sensor acts as a heat source approximating heat flow in one dimension. For Scanning Thermal Microscopy (SThM), Park XE7-AFM with thermal module was employed. For heat dissipation test, thermal imaging was carried out using a FLIR E40 thermal camera.

The heat dissipating polymer composition of the present invention introduces supramolecular chemistry to the thermal management area and at the same time highlight significant crucial drivers responsible for conduction of thermal phonons in polymers. These experiments showed that various factors like self-assembled 2-D layered sheet stacking structure of MC, enhanced intermolecular interactions, reduced interfacial thermal resistance and effective mixing strategy has been highlighted for the development of polymer based composites with enhanced TC. MC filler was incorporated in PVA matrix via in-situ co-precipitation method, which has been demonstrated effective to achieve uniform dispersion. The TC of MC-10 is around 1.24 times higher than PVA, while PVA filled with individual component of M (M-10) or C (C-10) shows reduced TC. The highest TC value was achieved at 50 wt % MC loading (MC-50), which is 1.67 times higher than neat PVA. The multiple hydrogen bonded pathways coupled with self-assembled layered structure of composite is responsible for its enhanced TC. It has been shown that this supramolecular assembly of MC in matrix led to enhanced intermolecular interactions due to the presence of several functional groups capable for efficient hydrogen bonding. Incorporation of MC fillers lead to the development of efficient self-assembled aligned 2-D stacking which effectively drives the thermal phonons along the MC crystal planes as well as filler-polymer interfaces. To conclude, these experiments have demonstrated that heat dissipating polymer materials prepared employing supramolecular assembly techniques described herein can be used to fabricate structural polymer composites with enhanced TC.

### EXAMPLES

The following examples are offered to more fully illustrate the invention, but are not to be construed as limiting the scope thereof. Further, while some of examples may include conclusions about the way the invention may function, the inventor do not intend to be bound by those conclusions, but put them forth only as possible explanations. Moreover, unless noted by use of past tense, presentation of an example does not imply that an experiment or procedure was, or was not, conducted, or that results were, or were not actually obtained. Efforts have been made to ensure accuracy with respect to numbers used (e.g., amounts, temperature), but some experimental errors and deviations may be present. Unless indicated otherwise, parts are parts by weight, molecular weight is weight average molecular weight, temperature is in degrees Centigrade, and pressure is at or near atmospheric.

### Materials

Poly-vinyl alcohol (PVA) was purchased from Sigma-Aldrich with degree of hydrolysis of 87-89% (average M_{w}=146,000-186,000 g/mol. Melamine (99%) and cyanuric acid (98%) were purchased from Sigma-Aldrich. Deionized water (Millipore) having a minimum resistivity of 18.2 MO-cm was used in all the experiments. All materials were used as received without further purification.

### Example 1

### Preparation of PVA Composite Films

A solvent casting method was used to prepare pure PVA and PVA composite films. Required amount of PVA was first dissolved in DI water at 90° C.-95° C. under magnetic stirring for 5 hours to make 7% aq. solution. After obtaining aqueous PVA solution, it was poured in glass petri dish and dried at 35° C. for 4 days to obtain freestanding films and later heated at 80° C. for another 1 day. For preparing composite films, required amount of M and C was separately dissolved in DI water at 90° C. Both solutions turn transparent after complete dissolution. M solution was firstly added into PVA solution and then C solution was added with mixing all though the process. The mixing continues for 3 hours at 85° C. Pure PVA film was prepared following the same procedure. Composite films with MC loading of 1 to 50 wt % were prepared in this study. All composite MC films have equimolar ratio of M and C. The term MC-X represents polymer composite film with X wt % loading of MC with adding sequence of M aq. solution first and then C aq. solution into PVA solution and similarly CM means vice-versa. The term MC-P-X represents composite films with X wt % loading prepared by mixing dry powder of MC into PVA solution. For comparison purpose, PVA/Melamine and PVA/Cyanuric acid composite films were also prepared which are named as M-X and C-X respectively.

In light of the foregoing, it should be appreciated that the present invention significantly advances the art by providing a heat dissipating polymer material that is structurally and functionally improved in a number of ways. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

What is claimed is:

1. A heat dissipating polymer composition comprising:
a substantially electrically non-conductive polymer; and
a self-assembling and self-aligning supramolecular filler material;
wherein said self-assembling and self-aligning supramolecular filler material comprises a plurality of substantially aligned 2D sheets.

2. The heat dissipating polymer composition of claim 1 wherein said substantially electrically non-conductive polymer is selected from the group consisting of poly(vinyl alcohol), polyvinyl propylene, polyamides, polyacrylic amides, polysaccharides, polyacrylic acids, polyurethanes with polyethylene glycol ether soft segments, and combinations, copolymers and grafts thereof.

3. The heat dissipating polymer composition of claim 1 wherein said substantially electrically non-conductive polymer is poly(vinyl alcohol).

4. The heat dissipating polymer composition of claim 1 wherein said self-assembling and self-aligning supramolecular filler material comprises one or more of melamine and cyanuric acid, adenine and guanine, thymine and adenine, cytosine and guanine or two or more ureidopyrimidinone derivatives.

5. The heat dissipating polymer composition of claim 1 wherein self-assembling and self-aligning supramolecular filler material comprises from about 20 wt % to about 80 wt % of said heat dissipating polymer composition.

6. The heat dissipating polymer composition of claim 1 having a thermal conductivity of from about 0.3 W/m·K to about 1.0 W/m·K.

7. The heat dissipating polymer composition of claim 4 wherein the molar ratio of melamine to cyanuric acid is about 1:1.

8. A heat dissipating polymer composite film comprising the heat dissipating polymer composition of claim 1.

9. The heat dissipating polymer composite film of claim 8 wherein the self-assembling and self-aligning supramolecular filler material comprises from about 20 wt % to about 80 wt % of said heat dissipating polymer composition.

10. The heat dissipating polymer composite film of claim 8 having a thickness of from about 10 microns to about 1 cm.

11. The heat dissipating polymer composite film of claim 8 wherein the substantially electrically non-conductive polymer comprises poly(vinyl alcohol).

12. The heat dissipating polymer composite film of claim 8 wherein the self-assembling and self-aligning supramolecular filler material comprises melamine and cyanuric acid.

13. The heat dissipating polymer composite film of claim 8 having a thermal conductivity of from about 0.3 W/m·K to about 1.0 W/m·K.

14. A method for making the heat dissipating polymer composite film of claim 8 comprising:
A) dissolving the substantially electrically non-conductive polymer in deionized water;
B) separately dissolving melamine and cyanuric acid in deionized water to form a melamine solution and a cyanuric acid solution;
C) separately adding the melamine solution and the cyanuric acid solution of step B to the solution of step A;
D) mixing the solution of step C at a temperature of from 25° C. to about 90° C. for from about 10 min to about 5 hours, wherein the melamine and cyanuric acid will self-assemble to form a plurality of substantially aligned 2D sheets within said substantially electrically non-conductive polymer;
E) pouring the solution of step D into a flat-bottomed container or onto a surface and drying it at a temperature of from about 25° C. to about 70° C. for from 1 to 7 days to form a freestanding film.

15. The method of claim 14 further comprising:
F) heating said freestanding film at a temperature of 40° C. to about 80° C. for from 1 to 48 hours to remove any remaining solvent.

16. The method of claim 14 wherein the substantially electrically non-conductive polymer is polyvinyl alcohol.

17. The method of claim 14 wherein the molar ratio of the molar ratio of melamine to cyanuric acid in step C is about 1:1.

18. The method of claim 14 wherein said melamine and cyanuric acid together comprise from about 5 wt % to about 80 wt % of said heat dissipating polymer composition.

19. The method of claim 14 wherein said melamine and cyanuric acid together comprise from about 20 wt % to about 80 wt % of said heat dissipating polymer composition.
